(19) United States
(12) Patent Application Publication
(10) Pub. No.: US 2023/0021021 A1
(43) Pub. Date: Jan. 19, 2023

(54) METHOD AND APPARATUS FOR PROVIDING COUNSELING SERVICE

(71) Applicant: KAKAO CORP., Jeju-si (KR)

(72) Inventors: Se Eun PARK, Seongnam-si (KR); Sung Yong CHANG, Seongnam-si (KR); Zong Muk YOON, Seongnam-si (KR); Hyun Soo PARK, Seongnam-si (KR); Bo Kuk PARK, Seongnam-si (KR); Yeo Seong YOON, Seongnam-si (KR); Jung Wook SON, Seongnam-si (KR); Woo Hyeok JUN, Seongnam-si (KR); Woo Seong LEE, Seongnam-si (KR); Jeong Hyeon LEE, Seongnam-si (KR); Sang Won LEE, Seongnam-si (KR); Yong Su PARK, Seongnam-si (KR)

(21) Appl. No.: 17/865,397

(22) Filed: Jul. 15, 2022

(30) Foreign Application Priority Data
Jul. 16, 2021 (KR) 10-2021-0093357

(51) Int. Cl. G06Q 30/00; H04L 51/04

(52) U.S. Cl. CPC G06Q 30/016; H04L 51/04

(57) ABSTRACT

Provided are a method and apparatus for providing a counseling service. A method of operating a counseling center server interworking with an instant messaging service includes creating, based on an input of a first user requesting counseling for a channel registered in the service, a first counseling ticket corresponding to the channel, determining whether the first counseling ticket is created due to switch to manned counseling during unmanned counseling based on a type of the requested counseling and a second counseling ticket created before the first counseling ticket by a request of the first user, updating an indicator for a counseling status of the channel based on a result of the determination and counseling data stored in correspondence with the second counseling ticket, and providing the updated indicator for the counseling status to a terminal of a second user linked to the channel.

### CROSS-REFERENCE TO RELATED APPLICATION

This application claims the benefit of Korean Patent Application No. 10-2021-0093357 filed on Jul. 16, 2021, in the Korean Intellectual Property Office, the entire disclosure of which is incorporated herein by reference for all purposes.

### BACKGROUND

### 1. Field of the Invention

One or more example embodiments relate to a method and apparatus for providing a counseling service.

### 2. Description of the Related Art

Recently, with development of mobile smart devices, the use of online platform services for interaction with other users through networks is increasing. Typical examples of the online platform services for interaction with other users include a social networking service (SNS), which is an online platform that creates and strengthens social relationships through communication, information sharing, and social network expansion among users, and an instant messaging service (IMS), which is an online platform for real-time content communication among two or more users. As the interaction among users through such mobile devices increases, the online platform service supports not only a chat service for daily conversation with other users, but also a function of providing various services based on communication among a plurality of users.

Contact center as a service (CCaaS), a cloud-based service-type contact center solution, may be a service that provides an online counseling platform with various counseling functions including a chat interface and a chatbot. There is a need for development of CCaaS technology for companies to efficiently conduct and manage counseling by applying smart technology while consumers may request non-face-to-face counseling using mobile devices in an easy and quick way.

### SUMMARY

According to an aspect, there is provided a method of operating a counseling center server interworking with an instant messaging service, including creating, based on an input of a first user requesting counseling for a channel registered in the service, a first counseling ticket corresponding to the channel, determining whether the first counseling ticket is created due to switch to manned counseling during unmanned counseling based on a type of the requested counseling and a second counseling ticket created before the first counseling ticket by a request of the first user, updating an indicator for a counseling status of the channel based on a result of the determination and counseling data stored in correspondence with the second counseling ticket, and providing the updated indicator for the counseling status to a terminal of a second user linked to the channel.

The determining of whether the first counseling ticket is created due to the switch to the manned counseling during the unmanned counseling may include determining that the first counseling ticket is created due to the switch to the manned counseling during the unmanned counseling when the first counseling ticket corresponding to the manned counseling is created within a predetermined threshold time after the second counseling ticket corresponding to the unmanned counseling is ended.

When it is determined that the first counseling ticket is created due to the switch to the manned counseling during the unmanned counseling as the result of the determination, the updating of the indicator for the counseling status of the channel may include updating an indicator for the number of times the switch to the manned counseling occurs during the unmanned counseling in correspondence with the channel, and updating an indicator for a chatbot block that causes the switch to the manned counseling during the unmanned counseling in correspondence with the channel based on the predetermined number of chatbot blocks called before an end of the second counseling ticket.

The creating of the first counseling ticket may include creating a first type of counseling ticket corresponding to the unmanned counseling or a second type of counseling ticket corresponding to the manned counseling based on the type of the requested counseling.

The creating of the first counseling ticket may further include storing counseling data transmitted to a chat room of the channel in correspondence with the first counseling ticket while the counseling corresponding to the first counseling ticket is being conducted.

When a type of the first counseling ticket is a first type corresponding to the unmanned counseling, the storing of the counseling data in correspondence with the first counseling ticket may include storing at least one of a massage of the first user transmitted to the chat room while the counseling corresponding to the first counseling ticket is being conducted, a chatbot block called based on the message of the first user, and an answer stored in a knowledge database called based on the message of the first user, in correspondence with the counseling ticket.

When a type of the first counseling ticket is a second type corresponding to the manned counseling, the storing of the counseling data to correspond to the first counseling ticket may include storing at least one of a message of the first user transmitted to the chat room while the counseling corresponding to the first counseling ticket is being conducted, a response message input by a counselor linked to the channel to correspond to the message of the first user, a chatbot block referenced by the counselor to correspond to the message of the first user, and an answer stored in a knowledge database referenced by the counselor to correspond to the message of the first user, in correspondence with the counseling ticket.

The second user may include at least one of at least one counselor linked to the channel and a manager of the channel.

The creating of the first counseling ticket corresponding to the channel may include creating a counseling center module corresponding to the channel in response to a request for opening a counseling center of the channel registered in the service, determining whether to link the counseling center module and a chatbot server through the channel and whether to link the counseling center module and a knowledge database based on a linkage policy regarding the counseling center module, receiving an input of the first user requesting the counseling through a chat room of the channel included in the counseling center module, and creating a first counseling ticket corresponding to the channel based on the input of the first user.

The counseling data may include at least one of a message transmitted to the chat room of the channel, a chatbot block acquired from a chatbot server linked to the counseling center module, and an answer stored in a knowledge database linked to the counseling center module in correspondence with a predetermined question.

According to another aspect, there is provided a method of operating a counseling center server interworking with an instant messaging service, including creating a first counseling ticket corresponding to manned counseling based on an input of a user requesting the manned counseling for a channel registered in the service, allocating the first counseling ticket to an account of a counselor linked to the channel, determining whether the first counseling ticket is created due to switch to the manned counseling during unmanned counseling based on an end time of a second counseling ticket corresponding to the unmanned counseling ended before the creation of the first counseling ticket, and providing information on a predetermined number of chatbot blocks called before the end of the second counseling ticket to a terminal of the counselor based on a result of the determination.

The determining of whether the first counseling ticket is created due to the switch to the manned counseling during the unmanned counseling may include determining that the first counseling ticket is created due to the switch to the manned counseling during the unmanned counseling when the first counseling ticket is created within a predetermined threshold time after the second counseling ticket is ended.

When it is determined that the first counseling ticket is created due to the switch to the manned counseling during the unmanned counseling as the result of determination, the providing of the information on the chatbot blocks to the terminal of the counselor may include providing information on the predetermined number of chatbot blocks called before the end of the second counseling ticket to the terminal of the counselor based on counseling data stored in correspondence with the second counseling ticket.

According to another aspect, there is provided is a counseling center server interworking with an instant messaging service including at least one processor which is configured to create a first counseling ticket corresponding to a channel registered in the service based on an input of a first user requesting counseling for the channel, determine whether the first counseling ticket is created due to switch to manned counseling during unmanned counseling based on a type of the requested counseling and a second counseling ticket created before the first counseling ticket at a request of the first user, update an indicator for a counseling status of the channel based on a result of the determination and counseling data stored in correspondence with the second counseling ticket, and provide the updated indicator for the counseling status to a terminal of a second user linked to the channel.

In determining whether the first counseling ticket is created due to the switch to the manned counseling during the unmanned counseling, the at least one processor may be configured to determine that the first counseling ticket is created due to the switch to the manned counseling during the unmanned counseling when the first counseling ticket corresponding to the manned counseling is created within a predetermined threshold time after the second counseling ticket corresponding to the unmanned counseling is ended.

In updating the indicator for the counseling status of the channel, when it is determined that the first counseling ticket is created due to the switch to the manned counseling during the unmanned counseling as the result of the determination, the at least one processor may be configured to update an indicator for the number of times the switch to the manned counseling occurs during the unmanned counseling in correspondence with the channel, and update an indicator for a chatbot block that causes the switch to the manned counseling during the unmanned counseling in correspondence with the channel based on a predetermined number of chatbot blocks called before an end of the second counseling ticket.

According to another aspect, there is provided is a counseling center server interworking with an instant messaging service including at least one processor configured to create a first counseling ticket corresponding to manned counseling based on an input of a user requesting the manned counseling for a channel registered in the service, allocate the first counseling ticket to an account of a counselor linked to the channel, determine whether the first counseling ticket is created due to switch to the manned counseling during unmanned counseling based on an end time of a second counseling ticket corresponding to unmanned counseling ended before the creation of the first counseling ticket, and provide information on a predetermined number of chatbot blocks called before the end of the second counseling ticket to a terminal of the counselor based on a result of the determination.

In determining whether the first counseling ticket is created due to the switch to the manned counseling during the unmanned counseling, the processor may be configured to determine that the first counseling ticket is created due to the switch to the manned counseling during the unmanned counseling when the first counseling ticket is created within a predetermined threshold time after the second counseling ticket is ended.

In providing the information on the chatbot blocks to the terminal of the counselor, when it is determined that the first counseling ticket is created due to the switch to the manned counseling during the unmanned counseling as the result of the determination, the processor may be configured to provide information on the predetermined number of chatbot blocks called before the end of the second counseling ticket to the terminal of the counselor based on counseling data stored in correspondence with the second counseling ticket.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is an operation flowchart illustrating a method of operating a counseling center server interworking with an instant messaging service according to an example embodiment;

FIGS. 2A to 2C are diagrams illustrating a linking structure of a counseling center module according to an example embodiment;

FIG. 3 is a diagram illustrating counseling data according to an example embodiment;

FIG. 4 is a diagram illustrating a criterion for determining switch to manned counseling during unmanned counseling according to an example embodiment;

FIGS. 5A and 5B are diagrams illustrating an example of an indicator for a counseling status according to an example embodiment;

FIG. 6 is an operation flowchart illustrating a method of operating a counseling center server interworking with an instant messaging service according to an example embodiment;

FIG. 7 is a diagram illustrating a screen of an interface related to a counseling center module according to an example embodiment;

FIG. 8 is a diagram illustrating a screen of an interface related to a counseling center module supporting a search function according to an example embodiment;

FIGS. 9A and 9B are diagrams illustrating a screen of an interface related to a counseling center module providing information on a chatbot block according to an example embodiment;

FIG. 10 is a diagram illustrating a screen of an interface related to a counseling center module providing an indicator for a counseling status according to an example embodiment; and

FIG. 11 is an exemplary diagram illustrating a configuration of a counseling system according to an example embodiment.

### DETAILED DESCRIPTION

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

As used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, components or a combination thereof, but do not preclude the presence or addition of one or more other features, integers, steps, operations, elements, components, and/or groups thereof.

Hereinafter, example embodiments will be described in detail with reference to the accompanying drawings. When describing the example embodiments with reference to the accompanying drawings, like reference numerals refer to like components and a repeated description related thereto will be omitted.

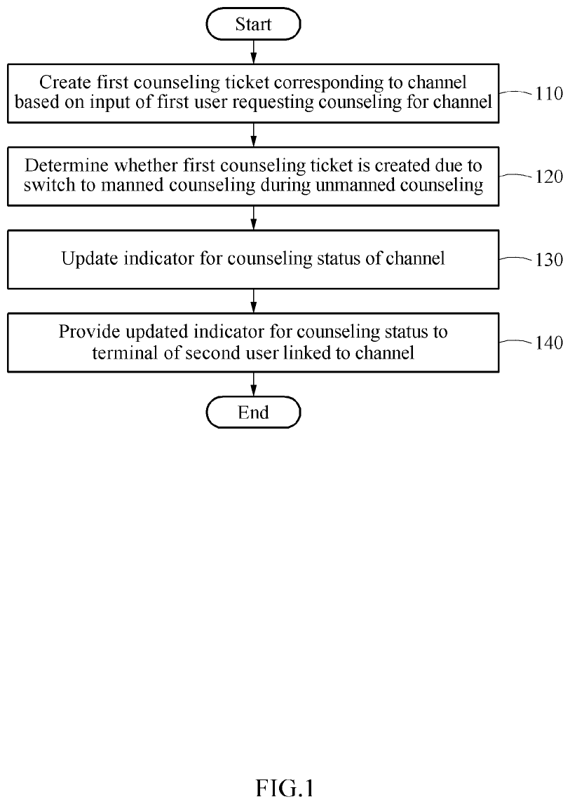

FIG. 1 is an operation flowchart illustrating a method of operating a counseling center server interworking with an instant messaging service according to an example embodiment.

Referring to FIG. 1, a method of operating a counseling center server interworking with an instant messaging service according to an example embodiment may include creating a first counseling ticket corresponding to a channel based on an input of a first user requesting counseling for a channel 110, determining whether the first counseling ticket is created due to switch to manned counseling during unmanned counseling 120, updating an indicator for a counseling status of the channel 130, and providing the updated indicator for the counseling status to a terminal of a second user linked to the channel 140.

According to an example embodiment, the counseling center server may correspond to a server that provides a counseling service by interworking with the instant messaging service. The counseling service is a counseling service that uses an instant messenger connected to an instant messaging server providing an instant messaging service as a counseling medium, and a user may use the counseling service by subscribing to the instant messaging service or through a registered account. The counseling center server and the instant messaging server may be included in a counseling system for providing the counseling service, and a detailed configuration of the counseling system will be described in detail below.

The instant messaging server according to an example embodiment may provide various types of accounts, such as a personal account, a corporate account, or a service account, to use the instant messaging service. The personal account may be an account for general users, the corporate account may be an account for specific companies, and the service account may be an account for specific services. The corporate account or the service account may be referred to as a channel.

The counseling service according to an example embodiment may be provided in the form of the counseling through a channel registered in the instant messaging service. Counseling through the channel may refer to the counseling conducted in a chatting manner between the channel and another account that requests the counseling on the channel. For example, the counseling service may be provided in a chatting manner using an instant messenger between a personal account (an individual account) of a user A corresponding to a general user and a channel of a user B corresponding to a specific company or a specific service provider. Hereinafter, the ‘counseling center server’ may be briefly referred to as a ‘server’.

Operation 110 according to an example embodiment may correspond to creating a first counseling ticket corresponding to a channel based on an input of a first user requesting the counseling on a channel registered in the instant messaging service. The channel registered in the instant messaging service may correspond to a corporate account or a service account of a specific user subscribed to the instant messaging service. The first user may correspond to a user who has a personal account, a corporate account, or a service account subscribed to the instant messaging service.

According to an example embodiment, the first user may request the instant messaging server for the counseling on the channel using a terminal. The counseling request for the channel may be transmitted to the counseling center server through the instant messaging server. According to an example embodiment, the terminal of the first user may directly transmit the input of the first user requesting the counseling for the channel to the counseling center server. For example, the terminal of the first user may receive a command of the first user for the counseling request from a website or application linked to the channel and transmit a signal requesting the counseling on the channel to the instant messaging server or the counseling center server. As another example, the terminal of the first user may request the instant messaging server for the counseling on the channel through an interface related to the channel provided by the instant messenger, and the instant messaging server may transmit a signal for the counseling request to the counseling center server.

According to an example embodiment, based on the input of the first user requesting the counseling on the channel, a counseling ticket for the channel and the account of the first user may be created. A counseling ticket is a unit of counseling objectified in the server, which may correspond to a session for the counseling between a specific user and a counselor or chatbot linked to a specific channel. The counseling between a specific user and a specific channel is objectified as a counseling ticket to be stored in the server, and the counseling ticket may include a chat log between the specific user and the specific channel transmitted and received during the counseling. The chat log between the specific user and the specific channel may correspond to the chat message details transmitted to the chat room of the channel created for the progress of the counseling corresponding to the counseling ticket.

The instant messaging server or the counseling center server according to an example embodiment may create a chat room of a channel in which the account of a first user participates in response to an input requesting the counseling for a channel received from the terminal of the first user. The chat room of a channel created in response to a counseling request input is a virtual chat space for conducting the counseling between a counselor linked to the channel and a user who requested the counseling. The counseling may be conducted as an account of a counselor linked to the channel and an account of a user requested the counseling transmit and receive messages through the chat room. As described above, a message transmitted through a chat room of a channel in which the account of the first user participates may be stored in correspondence with a counseling ticket corresponding to the counseling request for the channel of the first user.

The creating of a first counseling ticket (110) according to an example embodiment may include creating a first type of counseling ticket corresponding to the unmanned counseling or a second type of counseling ticket corresponding to the manned counseling, based on the type of counseling requested by the input of the first user.

The type of counseling according to an example embodiment may include an unmanned counseling type and a manned counseling type. The unmanned counseling is a type of counseling conducted without a counselor as a natural individual, and may include, for example, a counseling type conducted using a chatbot server and/or a counseling type conducted using a database. The unmanned counseling may include a type of counseling conducted in various ways without a counselor as a natural individual, but for convenience of explanation below, it will be described with examples that the unmanned counseling refers to the type of counseling conducted using a chatbot server that provides a chatbot service for the counseling and/or a knowledge database, which is a database developed for the counseling. The manned counseling is a type of counseling conducted with a counselor as a natural individual, and may include, for example, a counseling type conducted in a 1:1 chatting manner through a chat interface between a first user who requested the counseling and a counselor linked to the channel of the second user. The counselor linked to the channel of the second user may correspond to a user who is able to transmit and receive a chatting message related to the counseling with another user account requesting the counseling using the channel of the second user.

According to an example embodiment, the input of the first user requesting the counseling on a channel may include information indicating the type of counseling. For example, the input of the first user requesting the counseling on a channel may include an input for requesting chatting with a chatbot linked to the channel or an input for transmitting a message by designating a chatbot linked to the channel as a recipient. In this case, the input of the first user may correspond to an input for requesting the unmanned counseling for the channel. Also, for example, the input of the first user requesting the counseling on a channel may include an input for requesting chatting with a counselor linked to the channel or an input for transmitting a message by designating a counselor linked to the channel as a recipient. In this case, the input of the first user may correspond to an input for requesting the manned counseling for the channel.

According to an example embodiment, when the type of counseling requested by the input of the first user is the unmanned counseling, a first type of counseling ticket corresponding to the unmanned counseling may be created, and when the type of counseling requested by the input of the first user is the manned counseling, a second type of counseling ticket corresponding to the manned counseling may be created.

Operation 110 according to an example embodiment may include creating a counseling center module corresponding to the channel in response to a request for opening a counseling center of a channel registered in an instant messaging service, determining whether to link the counseling center module and the chatbot server through a channel and whether to link the counseling center module and the knowledge database, based on a linkage policy regarding the counseling center module, receiving an input from the first user requesting the counseling through a chat room of a channel included in the counseling center module, and creating a first counseling ticket corresponding to the channel based on the input of the first user.

The counseling center module is an instance created to correspond to a channel in a server, and may include data for providing and managing a counseling service for the channel. For example, the counseling center module may include data for providing the counseling services such as account(s) of the counselor(s) linked to the corresponding channel, chat room(s) created for the counseling of the channel, counseling history, and results of the conducted counseling. The counseling center module may correspond to an instance having a 1:1 corresponding relation with a channel, and a counseling center module corresponding to a specific channel may not correspond to another channel. The server may create and/or delete the counseling center module by the request of the channel. A channel in which the counseling center module is created may use a counseling service function provided in the server.

According to an example embodiment, the first user may request, using the terminal, the server for the counseling on a channel in which the counseling center module is created. A chat room of a channel created in response to a counseling request may be stored in the counseling center module corresponding to the channel.

According to an example embodiment, when a counseling center module corresponding to a channel is created, an account of a counselor linked to the channel may be registered in the counseling center module. The account of the counselor linked to the channel may correspond to an account granted with access to the chat room of the channel for the counseling included in the counseling center module corresponding to the channel. The right to access the chat room of the channel may correspond to the right to transmit a message through the chat room of the channel using the channel and receive the message transmitted through the chat room of the channel.

According to an example embodiment, the right to access the chat room of the channel of the account of a counselor linked to the channel may be limited to a part of the chat room of the channel. For example, of chat rooms created for the counseling of the channel, an account of a first counselor may have access right for some parts allocated to the account of a first counselor, and an account of a second counselor may have access right for the other part allocated to the account of the second counselor.

According to an example embodiment, when the counseling center module corresponding to the channel is created, the interface related to the counseling center module may be provided to a terminal logged in with the account of the counseling center manager and the terminal logged in with the account of the counselor registered in the counseling center module. The counseling center manager and the counselor may conduct the counseling with a user account who requested the counseling by accessing the chat room created for the counseling through the interface related to the counseling center module provided in the terminal and transmitting and receiving messages, and also use functions related to counseling services, such as using a search function for creation of messages for the counseling. A detailed configuration of an interface related to the counseling center module according to an example embodiment will be described in detail below.

According to an example embodiment, the counseling center module may be linked to at least one response medium. The response medium, a medium used to obtain a response to a message, may be used as a means to create a response message to a message transmitted by a user who requested the counseling in the unmanned counseling or to assist the counselor for conducting the counseling in the manned counseling. According to an example embodiment, the response medium may include a chatbot server and/or a knowledge database.

According to an example embodiment, the chatbot server is a server that provides a chatbot service designed to have a conversation or the counseling with a user. For example, a chatbot service configured to extract intent and an entity by parsing an input query and create a response corresponding to a query based on the extracted intent and entity. A response created to correspond to the query in the chatbot server may be output as a chatbot block. The chatbot block, an output unit designed to perform an action corresponding to the intent extracted from a query, may include, for example, parameters, functions, and algorithms for performing an action corresponding to the intent.

According to an example embodiment, the knowledge database is a database for storing data for conversation or the counseling with a user, and may include, for example, a database including a set of standardized questions and answers, a database storing data on a specific product or service, and a database storing data on a particular user. In response to an input corresponding to the stored query, the knowledge database may output an answer stored in correspondence with the query. For example, the knowledge database may store a set of standardized questions and answers, and when a query corresponding to the stored question is input, the answer stored in correspondence with the question may be output.

According to an example embodiment, the server may determine whether to link the counseling center module and the chatbot server through a channel and whether to link the counseling center module and the knowledge database based on a predefined linkage policy for the counseling center module.

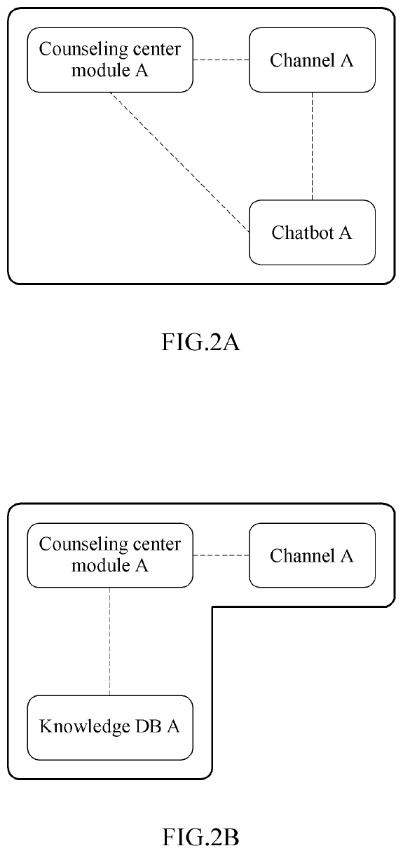

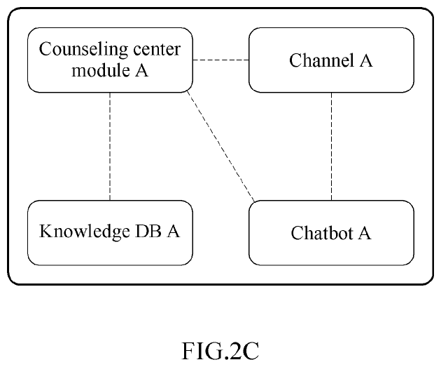

As an example, the linkage policy regarding linkage between the counseling center module and the chatbot server may include a policy for linking with a chatbot server linking with a channel corresponding to the counseling center module through the channel. For example, referring to FIG. 2A, when a channel A corresponding to a counseling center module A is linked to a chatbot A, the counseling center module A may be linked to the chatbot A through the channel A. In FIGS. 2A to 2C, the chatbot A may refer to a chatbot server. Hereinafter, the chatbot server linking with the counseling center module may refer to a chatbot server linking with the counseling center module through a channel.

As another example, the linkage policy regarding the linkage between the counseling center module and the knowledge database may include a policy for linking with the knowledge database into which connection information is input to correspond to the counseling center module. For example, referring to FIG. 2B, when connection information regarding a knowledge database A is input to the server to correspond to the counseling center module A, the counseling center module A may be linked to the knowledge database A.

According to an example embodiment, the connection information on the knowledge database is information required to access the knowledge database, and may include, for example, at least one of identification information of the knowledge database and an address of the knowledge database. When connection information regarding a specific knowledge database is input to correspond to the counseling center module, the server may link the counseling center module and the knowledge database.

According to an example embodiment, the counseling center module may be linked with both the knowledge database and the chatbot server. For example, referring to FIG. 2C, the counseling center module A may be linked with the chatbot A linked to the channel A corresponding to the counseling center module A according to the linkage policy and also be linked with the knowledge database A into which the connection information is input.

The chatbot server according to an example embodiment may be linked with a knowledge database, and may analyze the intent of a received message using the linked knowledge database or create a response to the received message. For example, the chatbot A linked with the counseling center module A may be linked with the knowledge database A linked with the counseling center module A, and the chatbot A may create a response to the query with reference to the knowledge database A. For another example, the chatbot A linked with the counseling center module A may be linked with the knowledge database A linked with the counseling center module A and another knowledge database B. In this case, the chatbot A may create a response to the query with reference to the knowledge database B.

Operation 110 according to an example embodiment may further include storing the counseling data transmitted to the chat room of the channel while conducting the counseling corresponding to the first counseling ticket in correspondence with the first counseling ticket. Counseling data may include at least one of a message transmitted to a chat room of a channel, a chatbot block obtained from a chatbot server linked with the counseling center module, and answers stored in correspondence with a predetermined question in the knowledge database linked with the counseling center module.

According to an example embodiment, when the type of the first counseling ticket is the first type corresponding to the unmanned counseling, a response message to the message of a first user transmitted to the chat room of the channel may be created based on the response the counseling center module corresponding to the channel and the chatbot server and/or the knowledge database linked through the channel. As an example, the message of the first user may be transmitted as a query to a chatbot server linked with the counseling center module corresponding to the channel, and the chatbot block corresponding to the query created in the chatbot server may be called as a response to the message of the first user. As another example, when the type of the first counseling ticket is the first type corresponding to the unmanned counseling, the message of the first user transmitted to the chat room of the channel may be transmitted, as a query, to the knowledge database linked to the counseling center module corresponding to the channel, and an answer stored in correspondence with the query in the knowledge database may be called in response to the message of the first user.

According to an example embodiment, when the type of the first counseling ticket is the first type corresponding to the unmanned counseling, the storing of the counseling data to correspond to the first counseling ticket may include storing, in correspondence with the counseling ticket, at least one of a message of the first user transmitted to the chat room, a chatbot block called based on the message of the first user, and an answer stored in the knowledge database called based on the message of the first user while conducting the counseling in correspondence with the first counseling ticket.

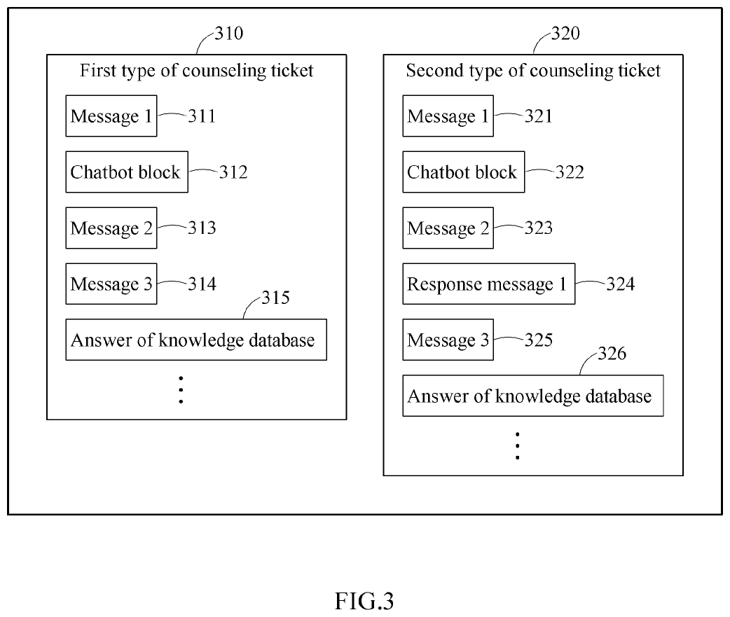

For example, referring to FIG. 3, when the type of the first counseling ticket is the first type corresponding to the unmanned counseling, messages 311, 313, and 314 of a first user transmitted to the chat room of the channel during the counseling corresponding to the first counseling ticket, a chatbot block 312 called in response to the message of the first user, and/or an answer 315 stored in the knowledge database may be stored as counseling data 310 corresponding to the first counseling ticket. For example, the counseling data may be stored in the order of time transmitted through the chat room. The counseling data 310 corresponding to the first counseling ticket may correspond to a case that the message 311 to the answer 315 of the knowledge database are transmitted in order through the chat room.

According to an example embodiment, when the type of the first counseling ticket is the second type corresponding to the manned counseling, the response message to the message of the first user transmitted to the chat room of the channel may be created based on the message input by a counselor linked to the counseling center module corresponding to the channel, the chatbot server referenced by the counselor, and/or the answer of the knowledge database. For example, the message of the first user may be transmitted to the terminal logged in with the account of the first counselor to which the first counseling ticket is allocated, and a response message input by the first counselor may be created. As another example, the terminal of the first counselor may request a search for the message of the first user to the chatbot server and/or the knowledge database linked to the counseling center module corresponding to the channel, and the chatbot block created in the chatbot server to correspond to the search request and/or the answer stored in the knowledge database may be transmitted to the terminal of the first counselor. The chatbot block referenced in the terminal of the first counselor by the request of the first counselor and/or the answer stored in the knowledge database may be created as a response message to the message of the first user.

According to an example embodiment, when the type of the first counseling ticket is the first type corresponding to the unmanned counseling, the storing of the counseling data in correspondence with the first counseling ticket may include storing, in correspondence with the counseling ticket, at least one of a message of a first user transmitted to a chat room while conducting the counseling corresponding to the first counseling ticket, a chatbot block called based on the message of a first user, and an answer stored in the knowledge database called based on the message of a first user.

For example, referring to FIG. 3, when the type of the first counseling ticket is the second type corresponding to the manned counseling, the messages 321, 323, and 325 of a first user transmitted to the chat room of the channel during the counseling corresponding to the first counseling ticket, a message 324 input by a first counselor obtained in response to the message of the first user, the chatbot block 322 referenced by the first counselor, and/or the answer 326 stored in the knowledge database may be stored as counseling data corresponding to the first counseling ticket.

Operation 120 according to an example embodiment may include determining whether the first counseling ticket is created by the switch to the manned counseling during the unmanned counseling, based on the type of counseling requested in operation 110 and the second counseling ticket created before the first counseling ticket by the request of the first user. The second counseling ticket is a counseling ticket created based on an input of the first user requesting the counseling on a channel, and may correspond to a counseling ticket created right before the first counseling ticket is created.

For example, the first user requested the unmanned counseling on a channel may request the end of the unmanned counseling for reasons of not being able to resolve the inquiry while conducting the counseling with the chatbot, and switch to the manned counseling during the unmanned counseling by requesting the manned counseling conducted with a counselor again.

As an example, the first counseling ticket created based on the input of the first user requesting the manned counseling on the channel may be a counseling ticket created by the switch to the manned counseling during the unmanned counseling and a counseling ticket created upon immediate request for the manned counseling by the first user. When the requested type of counseling is manned counseling, in order to determine whether the first counseling ticket is created due to the switch to the manned counseling during the unmanned counseling or created upon immediate request for the manned counseling, the server may use the criteria based on the type of the second counseling ticket that is ended after creation before the first counseling ticket and the end time of the second counseling ticket.

According to an example embodiment, when the type of counseling requested in operation 110 corresponds to the type of the manned counseling while the second counseling ticket created right before the first counseling ticket created in operation 110 corresponds to the first type of counseling ticket corresponding to the unmanned counseling, the server may compare a difference between the end time of the second counseling ticket and the creation time of the first counseling ticket with a predetermined threshold time to determine whether the first counseling ticket is created due to the switch to the manned counseling during the unmanned counseling.

According to an example embodiment, when the difference between the end time of the second counseling ticket and the creation time of the first counseling ticket is less than or equal to a predetermined threshold time, it is determined that the first counseling ticket is created due to the switch to the manned counseling during the unmanned counseling. On the other hand, even if the first counseling ticket corresponds to the type of manned counseling and the second counseling ticket to the type of unmanned counseling, when the difference between the end time of the second counseling ticket and the creation time of the first counseling ticket exceeds a predetermined threshold time, it may be determined that the first counseling ticket is not created due to the switch to the manned counseling during the unmanned counseling, but is created upon immediate request for the manned counseling.

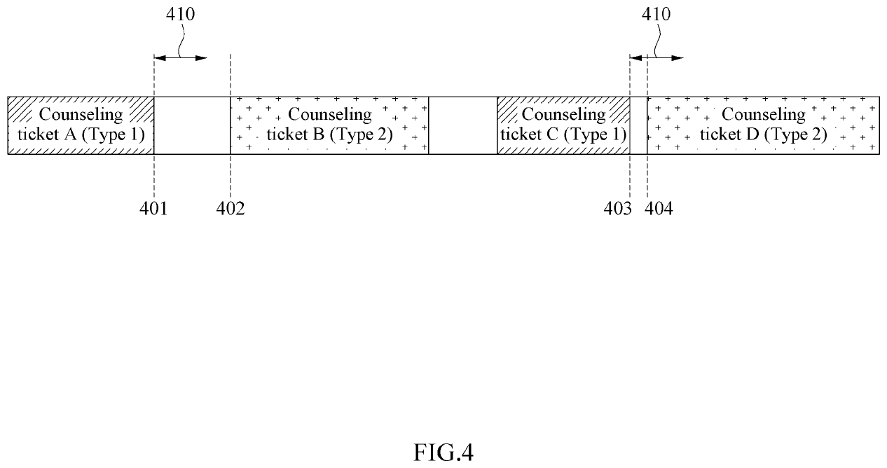

For example, referring to FIG. 4, based on an input of a first user requesting the counseling on a channel, when a first type of counseling ticket A, a second type of counseling ticket B, a first type of counseling ticket C, and a second type of counseling ticket D are created sequentially, whether the counseling ticket B is created due to the switch to the manned counseling during the unmanned counseling may be determined by comparing a difference between an end time 401 of the counseling ticket A created before the counseling ticket B and a creation time 402 of the counseling ticket B with a predetermined threshold time 410. Since the difference between the end time 401 of the counseling ticket A and the creation time 402 of the counseling ticket B exceeds the predetermined threshold time 410, it may be determined that the counseling ticket B is created upon immediate request for the manned counseling, rather than due to the switch to the manned counseling during the unmanned counseling. On the other hand, since the difference between an end time 403 of the counseling ticket C and a creation time 404 of the counseling ticket D is within the predetermined threshold time 410, it may be determined that the counseling ticket D is created due to the switch to the manned counseling during the unmanned counseling.

In other words, operation 120 of determining whether the first counseling ticket according to an example embodiment is created due to the switch to the manned counseling during the unmanned counseling may include determining that the first counseling ticket is created due to the switch to the manned counseling during the unmanned counseling when the first counseling ticket corresponding to the manned counseling is created within the predetermined threshold time after the second counseling ticket corresponding to the unmanned counseling is ended.

Operation 130 according to an example embodiment may include updating an indicator for a counseling status of a channel based on the result of the determination in operation 120 and the counseling data stored in correspondence with the second counseling ticket. The counseling data stored in correspondence with the second counseling ticket may correspond to the counseling data stored in correspondence with the second counseling ticket in the same way as the operation of storing the counseling data to correspond to the first counseling ticket described above.

The indicator for the counseling status of the channel according to an example embodiment is data that quantitatively and/or qualitatively represents the status of counseling conducted in the channel and may include, for example, an indicator for the number of counseling conducted in the channel and statistical indicators for a chatbot block used for counseling and answers of the knowledge database.

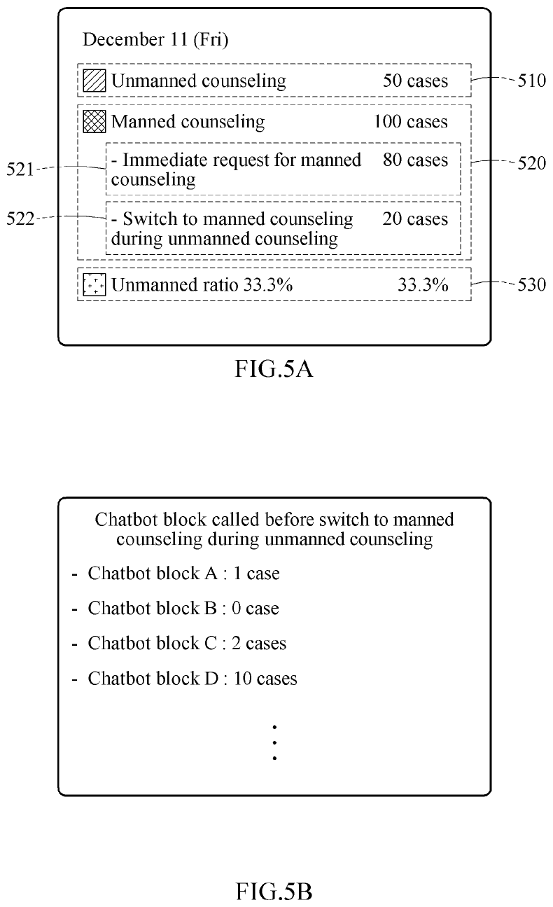

According to an example embodiment, the indicator for the number of counseling conducted in the channel may include data regarding the number and/or ratio of counseling per period and/or by type. For example, referring to FIG. 5A, the indicators for the counseling status of the channel may include the conducted number of unmanned counseling 510, the conducted number of manned counseling 520, and an unmanned ratio 530 as a ratio of the unmanned counseling out of entire counseling, in the channel for a specific period (e.g., a day). The conducted number of unmanned counseling 510 may correspond to the number of first type of counseling tickets created in the channel, and the conducted number of manned counseling 520 may correspond to the number of second type of counseling tickets created in the channel. The conducted number of manned counseling 520 may be divided into the number of manned counseling 521 conducted upon immediate request for the manned counseling and the number of manned counseling 522 conducted due to the switch to the manned counseling during the unmanned counseling.

According to an example embodiment, the statistical indicator regarding the chatbot block used for conducting the counseling and the answer of the knowledge database may include an indicator for the chatbot block that caused the switch to the manned counseling during the unmanned counseling. The indicator for the chatbot block that caused the switch to the manned counseling during the unmanned counseling may correspond to an indicator for providing information on how many switch requests to the manned counseling were made from which chatbot block before the switch takes place, when the switch to the manned counseling takes place during the unmanned counseling.

For example, referring to FIG. 5B, the indicator for the chatbot block that caused the switch to the manned counseling during the unmanned counseling may include statistical data that counts the number of times included in the predetermined number of chatbot blocks that were last called in the counseling ticket corresponding to the unmanned counseling before the switch to the manned counseling during the unmanned counseling by each type of the chatbot block. In an example shown in FIG. 5B, it is indicated that the frequency of requesting the switch to the manned counseling during the unmanned counseling is high in the order of the chatbot block D, the chatbot block C, the chatbot block A, and the chatbot block B.

According to an example embodiment, in addition to the above-described examples, the indicators for the counseling status of the channel may further include the ratio of chatbot blocks used in the process of the manned counseling, the number of counseling tickets for each type created in the channel as the ratio that the knowledge database-stored answers is used, and/or various indicators that may be derived based on the counseling data stored in correspondence with the counseling tickets.

According to an example embodiment, when it is determined that the first counseling ticket is created due to the switch to the manned counseling during the unmanned counseling as a result of determination in operation 120, operation 130 of updating the indicator for the counseling status of the channel may include updating an indicator for the number of times the switch to the manned counseling occurs during the unmanned counseling in correspondence with the channel, and updating an indicator for the chatbot block that causes the switch to the manned counseling during the unmanned counseling in correspondence with the channel base on the predetermined number of chatbot block called before the end of the second counseling ticket. For example, when it is determined that the first counseling ticket was created due to the switch to the manned counseling during unmanned counseling, the number of times the switch to the manned counseling occurs during the unmanned counseling or the number of manned counseling conducted as the switch to the manned counseling occurs during the unmanned counseling may be increased by one (1). In addition, information on the predetermined number of chatbot blocks that were last called in the second counseling ticket may be reflected on the indicator for the chatbot block that causes the switch to the manned counseling during the unmanned counseling.

According to an example embodiment, when it is not determined that the first counseling ticket was not created due to the switch to the manned counseling during the unmanned counseling as a result of determination in operation 120, the conducted number of unmanned counseling or the conducted number of manned counseling upon the immediate request for the manned counseling may be increased by 1 depending on the type of counseling requested in operation 130.

Operation 140 according to an example embodiment may include providing an indicator for the counseling status updated in operation 130 to the terminal of a second user linked to the channel. For example, the second user linked to the channel may include at least one of at least one counselor linked to the channel, and a manager of the channel. As another example, the second user linked to the channel may further include a manager of the counseling center module corresponding to the channel.

According to an example embodiment, the indicator for the updated counseling status may be visually provided through an interface related to the counseling center module provided to the terminal of the second user. As an example, the indicator for the counseling status may be provided in the form of a report. The second user may input a report creation request corresponding to the indicator for the counseling status through the interface provided to the terminal, and the server may receive the report creation request from the terminal and create the indicator for the counseling status in the form of a report to provide the same to the terminal of the second user. A detailed configuration of an interface related to the counseling center module that provides an indicator for the counseling status according to an example embodiment will be described in detail below.

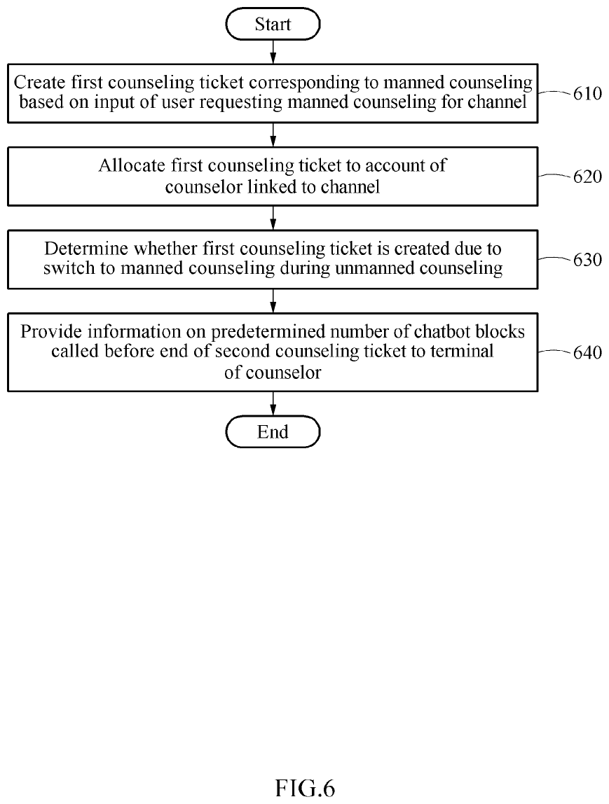

FIG. 6 is an operation flowchart of a method of operating a counseling center server interworking with an instant messaging service according to an example embodiment.

Referring to FIG. 6, according to an example embodiment, the method of operating a counseling center server interworking with an instant messaging service may include creating a first counseling ticket corresponding to the manned counseling based on an input of a user requesting the manned counseling on a channel 610, allocating the first counseling ticket to an account of a counselor linked to the channel 620, determining whether the first counseling ticket is created due to the switch to the manned counseling during the unmanned counseling 630, and providing information on a predetermined number of chatbot blocks called before the end of the second counseling ticket to the terminal of the counselor 640.

According to an example embodiment, operation 610 may include creating a first counseling ticket corresponding to the manned counseling based on an input of a user requesting the manned counseling on a channel registered in the instant messaging service. The user who requested the counseling in operation 610 may be referred to as a first user.

Operation 620 according to an example embodiment may include allocating the created first counseling ticket to any one of accounts of a counselor linked to the channel. As described above, the account of the counselor linked to the channel may correspond to an account of a counselor registered in the counseling center module corresponding to the channel. Hereinafter, the account of the counselor to which the first counseling ticket is allocated may be referred to as an account a first counselor. When the first counseling ticket is allocated to the account of the first counselor among the accounts of counselors linked to the channel, the first counselor may access the chat room of the channel for the counseling corresponding to the first counseling ticket and conduct the counseling by transmitting and receiving a message to and from the user who requested the counseling through the chat room.

Operation 630 according to an example embodiment may include, based on the end time of the second counseling ticket corresponding to the unmanned counseling ended before the creation of the first counseling ticket, determining whether the first counseling ticket is created due to the switch to the manned counseling during the unmanned counseling. The second counseling ticket is a counseling ticket created right before the first counseling ticket and may correspond to a counseling ticket created by the counseling request of the first user.

According to an example embodiment, operation 630 of determining whether the first counseling ticket is created due to the switch to the manned counseling during the unmanned counseling may include, as described above, when the first counseling ticket is created within a predetermined threshold time after the second counseling ticket is ended, determining that the first counseling ticket is created due to the switch to the manned counseling during the unmanned counseling.

Operation 640 according to an example embodiment may include, based on the result of determination in operation 630, providing information on a predetermined number of chatbot blocks called before the end of the second counseling ticket to the terminal of the counselor. The terminal of the counselor to which information on the chatbot block is provided may correspond to a terminal logged in with an account of a first counselor to which the first counseling ticket is allocated.

According to an example embodiment, when it is determined that the first counseling ticket is created due to the switch to the manned counseling during the unmanned counseling as a result of determination in operation 630, operation 640 of providing information on the chatbot block to the terminal of the counselor may include providing information on the predetermined number of chatbot blocks called before the end of the second counseling ticket to the terminal of the first counselor based on the counseling data stored in correspondence with the second counseling ticket.

According to an example embodiment, information on the predetermined number of chatbot blocks called before the end of the second counseling ticket may be visually provided through an interface related to a counseling center module provided to the terminal of the first counselor. As an example, the information on the predetermined number of chatbot blocks called before the end of the second counseling ticket may include information indicating the type of chatbot block and may be implemented as an interfacing object including a function of calling a screen on which a message corresponding to the chatbot block is displayed in response to the selected input of the first counselor. A detailed configuration of an interface related to a counseling center module that provides information on a chatbot block according to an example embodiment will be described in detail below.

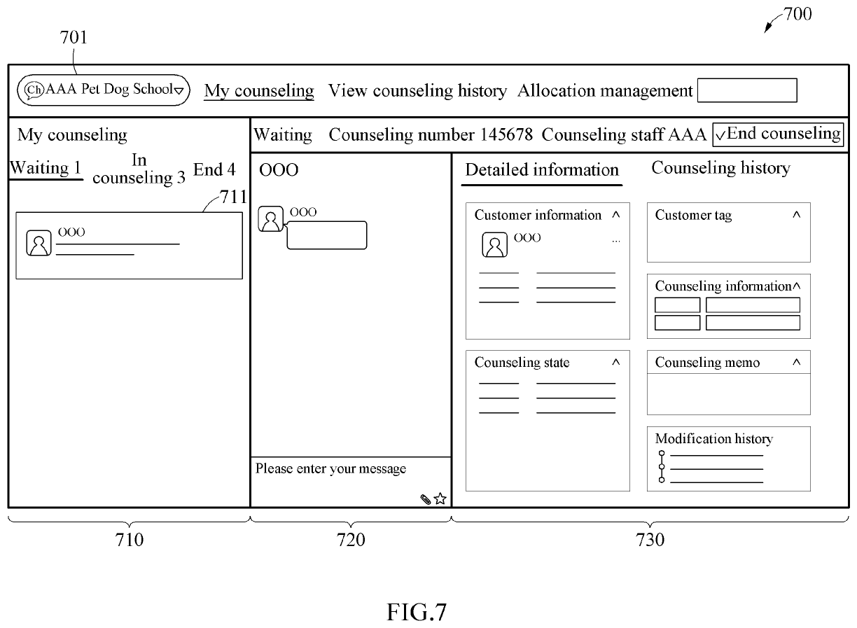

FIG. 7 is a diagram illustrating a screen of an interface related to a counseling center module according to an example embodiment.

Referring to FIG. 7, an interface 700 relating to the counseling center module corresponding to a specific channel 701 according to an example embodiment may be provided to a terminal (hereinafter, referred to as a terminal of a counselor) logged in with an account of a counselor linked to the corresponding channel. The interface 700 provided to the terminal of the counselor may include a list 710 of chat rooms allocated to the account of the counselor. By selecting (e.g., clicking) an interfacing object 711 related to the chat room displayed in the list of chat rooms, the counselor may request the server for an access to the chat room. For example, when the counselor requests the server for an access to the chat room by clicking the interfacing object 711 related to the chat room, the server may respond to the access request and provide a chat window 720 corresponding to the chat room to the terminal of the counselor. The terminal of the counselor may request, in response to a message input by the counselor in the chat window 720, the server to transmit a message to the account of the user participating in the chat room. The counselor may conduct the counseling with the user by transmitting and receiving messages to and from the account of the user participating in the chat room through the chat window 720.

According to an example embodiment, the chat interface 700 may further include a window 730 for providing information on the counseling in addition to the chat room list 710 and the chat window 720. The information on the counseling may include, for example, information on a user who requested the counseling, information on the status of the counseling, and information on the duration of the counseling.

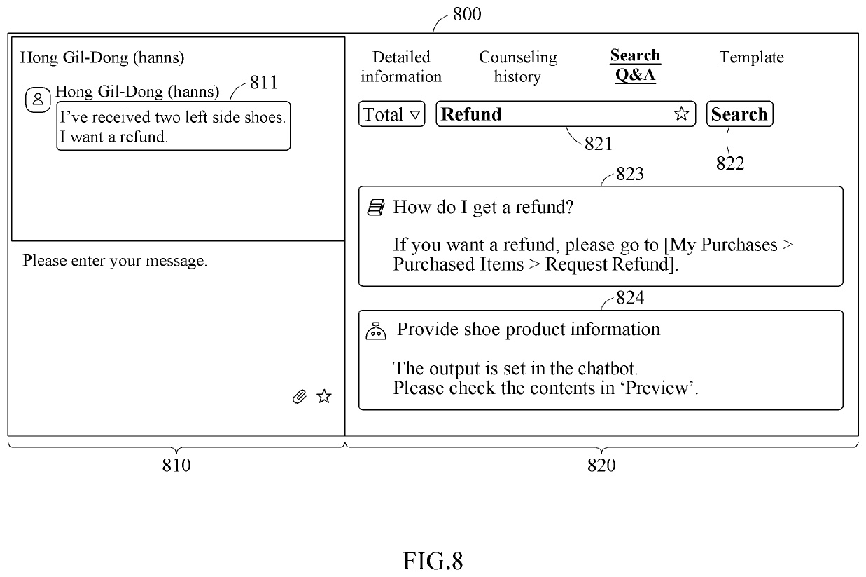

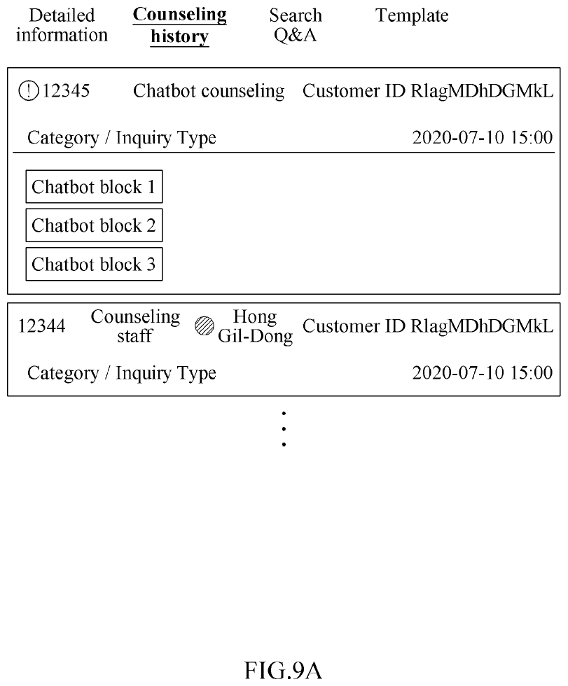

FIG. 8 is a diagram illustrating a screen of an interface related to a counseling center module supporting a search function according to an example embodiment.

As described above, the counselor linked to a specific channel may access the chat room of the channel created for the counseling through the interface related to the counseling center module provided in the terminal to conduct the counseling in a chatting manner with a user account who requested the counseling. For creation of a response message for the counseling, a search for a message received through a chat room of a channel may be requested to a chatbot server and/or a knowledge database linked to the counseling center module.

Referring to FIG. 8, an interface 800 related to the counseling center module provided to a terminal of a counselor may include a search interface 820 for a search function to transmit a search request to a chat window 810 corresponding to a chat room and a server and receive a search result. A message 811 transmitted to the chat room for the counseling may be displayed through the chat window 810, and the counselor may request the server for a search for a specific search word based on the message 811 through the search window 821 included in the search interface 820.

For example, the counselor may directly input a search word (e.g., “refund”) into the search window 821 based on the message 811 requesting a refund received through the chat room. For another example, although not shown in FIG. 8, the interface related to the counseling center module may provide a function of transmitting a search request for the entire message to the server.

According to an example embodiment, the terminal of the counselor may transmit a signal for requesting a search for the input search word to the server in response to the input of the counselor selecting a ‘search’ button 822, and the server may transmit the search request to the chatbot server and/or the knowledge database linked to the counseling center module.

According to an example embodiment, in response to a search request, the chatbot block created in the chatbot server and/or an answer stored in the knowledge database may be transmitted to the server, and the server may provide a search result 824 of the chatbot server corresponding to the received chatbot block and/or a search result 823 of the knowledge database corresponding to the received answer stored in the knowledge database to the terminal of the counselor through the interface.

According to an example embodiment, the terminal of the counselor may request, based on an input of the counselor selecting any one of the search results 823 and 824, a server for transmission of a response message created based on chatbot block correspond to the search result and/or the answer stored in the knowledge database. The search result selected to be created as the response message by the counselor may correspond to the chatbot block referenced in the terminal of the counselor and/or the answer stored in the knowledge database. In other words, the chatbot block referenced in the terminal of the counselor and/or the answer stored in the knowledge database may be created as a response message to the message of the user who requested the counseling.

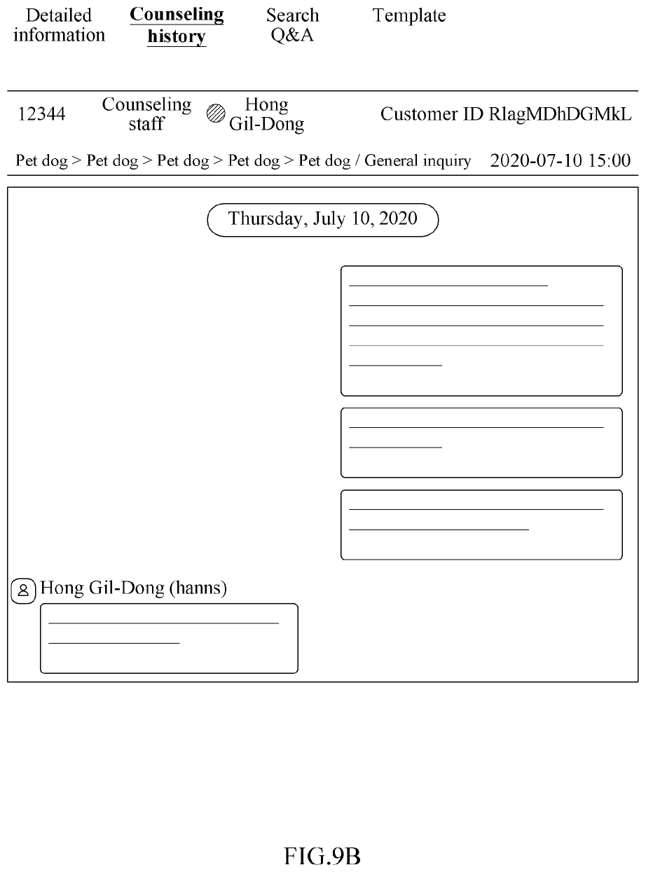

FIGS. 9A and 9B shows diagrams illustrating a screen of an interface related to a counseling center module providing information on a chatbot block according to an example embodiment.

As described above, the first counseling ticket created by the counseling request on the channel of the first user may be allocated to the account of a first counselor linked to the channel, and an interface related to a counseling center module for conducting the counseling corresponding to a first counseling ticket may be provided to the terminal logged in with an account of the first counselor.

Referring to FIG. 9A, the interface related to the counseling center module provided to the terminal of the first counselor may provide details on counseling tickets 910 and 920 created by the request of the first user for counseling on the channel. The counseling tickets 910 and 920 included in the history may correspond to counseling tickets corresponding to an end state. It may be assumed that the counseling ticket 910 corresponds to a second counseling ticket created before the first counseling ticket.

As described above, when it is determined that the first counseling ticket allocated to the account of the first counselor is created due to the switch to the manned counseling during the unmanned counseling, information on a predetermined number of chatbot blocks called before the end of the second counseling ticket may be provided based on counseling data stored in correspondence with the second counseling ticket in the terminal of the first user. As an example, the interface related to the counseling center module provided to the terminal of the first counselor may include interfacing objects 911, 912, and 913 for providing information on a predetermined number (e.g., three) of chatbot blocks called before the end of the second counseling ticket. The interfacing objects 911, 912, and 913 may include information indicating the type of the chatbot block called before the end of the second counseling ticket, and also include a function of calling a screen on which a message corresponding to the chatbot block is displayed in response to a selection input.

For example, when an input for selecting the interfacing object 911 is received, the screen of the interface shown in FIG. 9A may be switched to a screen of the interface shown in FIG. 9B. Referring to FIG. 9B, a chat window in which a message of a chatbot block corresponding to an interfacing object (e.g., an interfacing object 911 in FIG. 9A) selected through an interface may be provided.

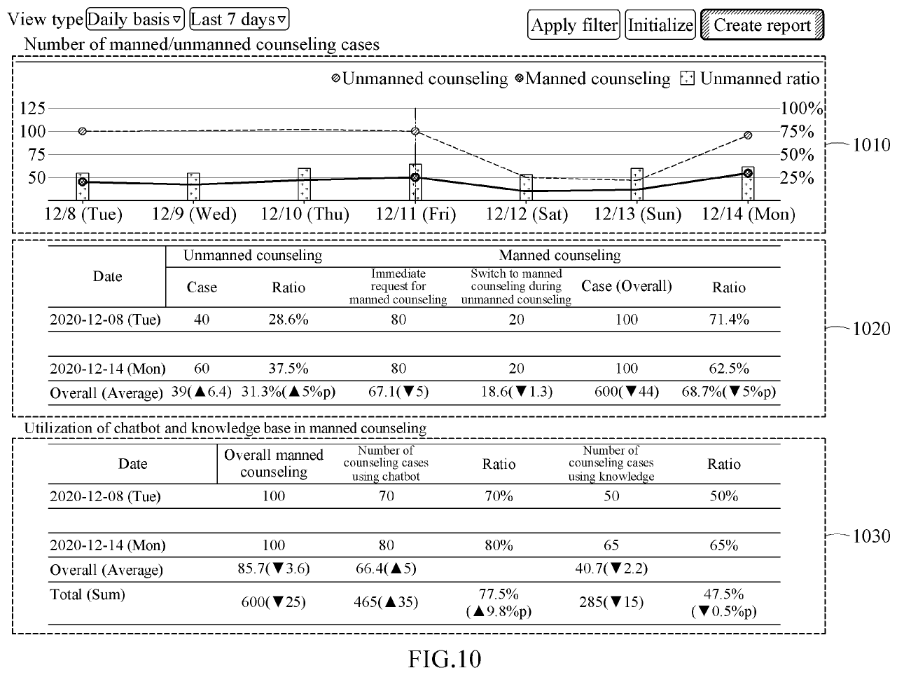

FIG. 10 is a diagram illustrating a screen of an interface related to a counseling center module that provides an indicator regarding a counseling status according to an example embodiment.

As described above, the indicator for the counseling status may be visually provided through an interface related to the counseling center module provided to the terminal of the second user. For example, the indicator for the counseling status may be provided in a form of a report.

Referring to FIG. 10, an indicator for the counseling status may be visually provided to the terminal of the second user through an interface. For example, the indicator for the number of counseling conducted in the channel may include data regarding the number and/or ratio of counseling by period and/or type, and may be visually provided as a graph 1010 and a table 1020 shown with specific numerical values for the number of times the unmanned counseling conducted each day included in a specific period of time (e.g., a week), the number of times the manned counseling conducted, and an unmanned ratio as a ratio of the unmanned counseling out of the entire counseling.

For another example, the statistical indicators regarding chatbot block used during the counseling and the answer of the knowledge database may include the ratio in which the chatbot block is used while conducting the manned counseling and the ratio in which the answers stored in the knowledge database is used, and may be visually provided through a table 1030 shown with specific numerical values for a ratio in which the chatbot block was used while conducting the manned counseling each day included in a specific period (e.g., a week) and a ratio in which the answer stored in the knowledge database was used.

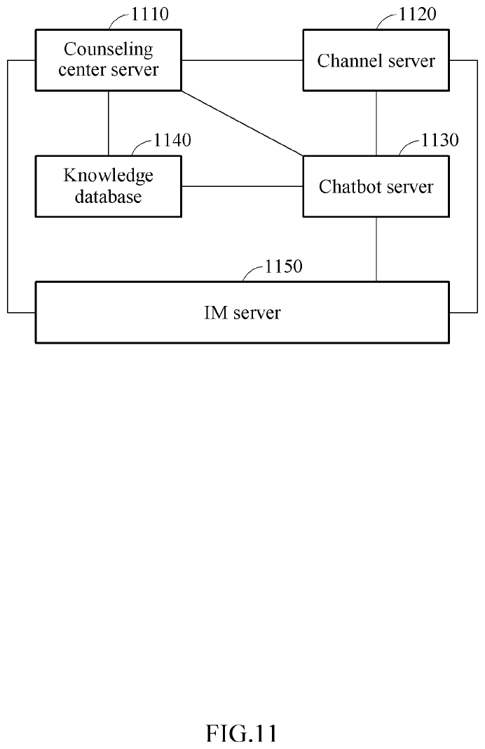

FIG. 11 is an exemplary diagram illustrating a configuration of a counseling system according to an example embodiment.

Referring to FIG. 11, a counseling system according to an example embodiment may include a counseling center server 1110, a channel server 1120, a chatbot server 1130, a knowledge database 1140, and an instant messaging server (hereinafter, IM server 1150).

The counseling system may perform an action related to a counseling service conducted in a chatting manner between a personal account of a user (hereinafter, a first user) corresponding to a general user and a channel (hereinafter, a first channel) of a user corresponding to a specific company or a specific service provider. As described above, the counseling center server 1110 may create a counseling center module corresponding to a channel.

According to an example embodiment, the message transmitted from the terminal of the first user through the chat room of the channel may be transmitted to the IM server 1150, and the IM server 1150 may transmit the same to the counseling center server 1110 or the chatbot server 1130. For example, the IM server 1150 may transmit the message to the counseling center server 1110 when the message is transmitted to the counselor, and transmit the message to the chatbot server 1130 when the message is transmitted to the chatbot. The message transmitted to the chatbot server 1130 may be transmitted from the chatbot server 1130 to the counseling center server 1110. The chatbot server 1130 may create a response message for the message, and transmit the created response message to the terminal of the first user through the IM server 1150.

According to an example embodiment, the message transmitted from the terminal of the first user through the chat room of the channel may be transmitted to the IM server 1150, and the IM server 1150 may transmit the same to the channel server 1120 so that the channel server 1120 may transmit the same to the counseling center server 1110 or the chatbot server 1130. The channel server 1120 may process the branching of a path through which the message is transmitted. In case of a message transmitted to the counselor, the message may be transmitted to the counseling center server 1110. In case of a message is transmitted to the chatbot, the message may be transmitted to the chatbot server 1130.

According to an example embodiment, when a counseling ticket corresponding to the chat room of the channel through which the message is transmitted is not created, the counseling center server 1110 may create a counseling ticket corresponding to the chat room. According to an example embodiment, while transmitting the message from the chatbot server 1130 to the counseling center server 1110, it is possible to request the counseling center server 1110 for creation of a counseling ticket. The counseling center server 1110 receiving the request for creating a counseling ticket from the chatbot server 1130 may create a first type of counseling ticket.

The counseling center server 1110 may allocate the second type of counseling ticket created to correspond to the chat room of the first channel to any one of accounts of the counselor linked to the first channel. The counseling center server 1110 may transmit a message received through the chat room corresponding to the second type of counseling ticket to the terminal of the counselor to which the counseling ticket is allocated. The terminal of the counselor may request transmission of a message through the chat room corresponding to the counseling ticket allocated to the counseling center server 1110, and the counseling center server 1110 may transmit the message to the terminal of the user connected to the chat room through the IM server 1150.

According to an example embodiment, the terminal of the counselor may request a search for a message transmitted to a chat room corresponding to a counseling ticket allocated to the counseling center server 1110. As described above, the counseling center server 1110 may transmit a search request to the chatbot server 1130 and/or the knowledge database 1140 based on the linking structure of the counseling center module corresponding to the channel.

According to an example embodiment, the counseling center server may include a processor and a memory.

The processor of the counseling center server according to an example embodiment may perform at least one operation described above with reference to FIGS. 1 to 11. For example, the processor may perform operations of the counseling center server interworking with the instant messaging service described above with reference to FIG. 1 and/or operations of the counseling center server linking with the instant messaging service described with reference to FIG. 6. In addition, the interface described above with reference to FIGS. 7 to 10 may be provided to the terminal of the counselor.

The memory of the counseling center server according to an example embodiment may be a computer-readable recording medium which may be a volatile memory or a non-volatile memory. The memory according to an example embodiment may store information on the provision of the counseling service described above with reference to FIGS. 1 to 11. For example, the memory of the server may store accounts of users registered in the server, and may store a counseling center module created to correspond to a channel registered in the server.

According to an example embodiment, the memory of the counseling center server may store a program in which at least one operation described above with reference to FIGS. 1 to 11 is executed. The processor of the counseling center server may execute a program stored in the memory and control the server. The code of the program executed by the processor of the counseling center server may be stored in the memory.

The example embodiments described herein may be implemented using hardware components, software components, or a combination thereof. For example, the apparatus, method, and components described in the example embodiments may be implemented using a general purpose computer or special purpose computer, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may run an operating system (OS) and one or more software applications that run on the OS. The processing device also may access, store, manipulate, process, and create data in response to execution of the software. For purpose of simplicity, the description of a processing device is used as singular, however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described example embodiments, or vice versa.

While this disclosure includes example embodiments, it will be apparent to one of ordinary skill in the art that various changes in form and details may be made in these example embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating a counseling center server interworking with an instant messaging service, the method comprising:
creating, based on an input of a first user requesting counseling for a channel registered in the service, a first counseling ticket corresponding to the channel;
determining whether the first counseling ticket is created due to switch to manned counseling during unmanned counseling based on a type of the requested counseling and a second counseling ticket created before the first counseling ticket by a request of the first user;
updating an indicator for a counseling status of the channel based on a result of the determination and counseling data stored in correspondence with the second counseling ticket; and
providing the updated indicator for the counseling status to a terminal of a second user linked to the channel.

2. The method of claim 1, wherein the determining of whether the first counseling ticket is created due to the switch to the manned counseling during the unmanned counseling comprises:
determining that the first counseling ticket is created due to the switch to the manned counseling during the unmanned counseling when the first counseling ticket corresponding to the manned counseling is created within a predetermined threshold time after the second counseling ticket corresponding to the unmanned counseling is ended.

3. The method of claim 1, wherein, when it is determined that the first counseling ticket is created due to the switch to the manned counseling during the unmanned counseling as the result of the determination,
the updating of the indicator for the counseling status of the channel comprises:
updating an indicator for the number of times the switch to the manned counseling occurs during the unmanned counseling in correspondence with the channel; and
updating an indicator for a chatbot block that causes the switch to the manned counseling during the unmanned counseling in correspondence with the channel based on a predetermined number of chatbot blocks called before an end of the second counseling ticket.

4. The method of claim 1, wherein the creating of the first counseling ticket comprises:
creating a first type of counseling ticket corresponding to the unmanned counseling or a second type of counseling ticket corresponding to the manned counseling based on the type of the requested counseling.

5. The method of claim 1, wherein the creating of the first counseling ticket further comprises:
storing counseling data transmitted to a chat room of the channel in correspondence with the first counseling ticket while the counseling corresponding to the first counseling ticket is being conducted.

6. The method of claim 5, wherein, when a type of the first counseling ticket is a first type corresponding to the unmanned counseling,
the storing of the counseling data in correspondence with the first counseling ticket comprises storing, in correspondence with the first counseling ticket, at least one of:
a massage of the first user transmitted to the chat room while the counseling corresponding to the first counseling ticket is being conducted;
a chatbot block called based on the message of the first user; and
an answer stored in a knowledge database called based on the message of the first user.

7. The method of claim 5, wherein, when a type of the first counseling ticket is a second type corresponding to the manned counseling,
the storing of the counseling data to correspond to the first counseling ticket comprises storing, in correspondence with the first counseling ticket, at least one of:
a message of the first user transmitted to the chat room while the counseling corresponding to the first counseling ticket is being conducted;
a response message input by a counselor linked to the channel to correspond to the message of the first user;
a chatbot block referenced by the counselor to correspond to the message of the first user; and
an answer stored in a knowledge database referenced by the counselor to correspond to the message of the first user.

8. The method of claim 1, wherein the second user comprises at least one of at least one counselor linked to the channel and a manager of the channel.

9. The method of claim 1, wherein the creating of the first counseling ticket corresponding to the channel comprises:
creating a counseling center module corresponding to the channel in response to a request for opening a counseling center of the channel registered in the service;
determining whether to link the counseling center module and a chatbot server through the channel and whether to link the counseling center module and a knowledge database based on a linkage policy regarding the counseling center module;
receiving an input of the first user requesting the counseling through a chat room of the channel included in the counseling center module; and
to creating a first counseling ticket corresponding to the channel based on the input of the first user.

10. The method of claim 9, wherein the counseling data comprises at least one of:
a message transmitted to the chat room of the channel;
a chatbot block acquired from a chatbot server linked to the counseling center module; and
an answer stored in a knowledge database linked to the counseling center module in correspondence with a predetermined question.

11. A method of operating a counseling center server interworking with an instant messaging service, the method comprising:
creating a first counseling ticket corresponding to manned counseling based on an input of a user requesting the manned counseling for a channel registered in the service;
allocating the first counseling ticket to an account of a counselor linked to the channel;
determining whether the first counseling ticket is created due to switch to the manned counseling during unmanned counseling based on an end time of a second counseling ticket corresponding to the unmanned counseling ended before the creation of the first counseling ticket; and
providing information on a predetermined number of chatbot blocks called before the end of the second counseling ticket to a terminal of the counselor based on a result of the determination.

12. The method of claim 11, wherein the determining of whether the first counseling ticket is created due to the switch to the manned counseling during the unmanned counseling comprises:
determining that the first counseling ticket is created due to the switch to the manned counseling during the unmanned counseling when the first counseling ticket is created within a predetermined threshold time after the second counseling ticket is ended.

13. The method of claim 11, wherein, when it is determined that the first counseling ticket is created due to the switch to the manned counseling during the unmanned counseling as the result of determination,
the providing of the information on the chatbot blocks to the terminal of the counselor comprises:
providing information on the predetermined number of chatbot blocks called before the end of the second counseling ticket to the terminal of the counselor based on counseling data stored in correspondence with the second counseling ticket.

14. A computer program stored in a non-transitory computer-readable medium in combination with hardware to execute the method of claim 1.

15. A counseling center server interworking with an instant messaging service, comprising at least one processor configured to:
create a first counseling ticket corresponding to a channel registered in the service based on an input of a first user requesting counseling for the channel;
determine whether the first counseling ticket is created due to switch to manned counseling during unmanned counseling based on a type of the requested counseling and a second counseling ticket created before the first counseling ticket at a request of the first user;
update an indicator for a counseling status of the channel based on a result of the determination and counseling data stored in correspondence with the second counseling ticket; and
provide the updated indicator for the counseling status to a terminal of a second user linked to the channel.

16. The counseling center server of claim 15, wherein the at least one processor is configured to, in determining whether the first counseling ticket is created due to the switch to the manned counseling during the unmanned counseling, determine that the first counseling ticket is created due to the switch to the manned counseling during the unmanned counseling when the first counseling ticket corresponding to the manned counseling is created within a predetermined threshold time after the second counseling ticket corresponding to the unmanned counseling is ended.

17. The counseling center server of claim 15, wherein the at least one processor is configured to:
in updating the indicator for the counseling status of the channel,
when it is determined that the first counseling ticket is created due to the switch to the manned counseling during the unmanned counseling as the result of the determination,
update an indicator for the number of times the switch to the manned counseling occurs during the unmanned counseling in correspondence with the channel; and
update an indicator for a chatbot block that causes the switch to the manned counseling during the unmanned counseling in correspondence with the channel based on a predetermined number of chatbot blocks called before an end of the second counseling ticket.

18. A counseling center server interworking with an instant messaging service, comprising at least one processor configured to:
create a first counseling ticket corresponding to manned counseling based on an input of a user requesting the manned counseling for a channel registered in the service;
allocate the first counseling ticket to an account of a counselor linked to the channel;
determine whether the first counseling ticket is created due to switch to the manned counseling during unmanned counseling based on an end time of a second counseling ticket corresponding to unmanned counseling ended before the creation of the first counseling ticket; and
provide information on a predetermined number of chatbot blocks called before the end of the second counseling ticket to a terminal of the counselor based on a result of the determination.

19. The counseling center server of claim 18, wherein the processor is configured to:
in determining whether the first counseling ticket is created due to the switch to the manned counseling during the unmanned counseling,
determine that the first counseling ticket is created due to the switch to the manned counseling during the unmanned counseling when the first counseling ticket is created within a predetermined threshold time after the second counseling ticket is ended.

20. The counseling center server of claim 18, wherein the processor is configured to:
in providing the information on the chatbot blocks to the terminal of the counselor,
when it is determined that the first counseling ticket is created due to the switch to the manned counseling during the unmanned counseling as the result of the determination,
provide information on the predetermined number of chatbot blocks called before the end of the second counseling ticket to the terminal of the counselor based on counseling data stored in correspondence with the second counseling ticket.
